(19) United States
(12) Patent Application Publication
(10) Pub. No.: US 2014/0375504 A1
(43) Pub. Date: Dec. 25, 2014

(54) SYSTEM FOR LOCATING A MISSING AIRCRAFT

(71) Applicant: THALES, Neuilly Sur Seine (FR)

(72) Inventor: Hugues Meunier, Frouzins (FR)

(21) Appl. No.: 14/308,164

(22) Filed: Jun. 18, 2014

(30) Foreign Application Priority Data
Jun. 20, 2013 (FR) FR1301439

(51) Int. Cl. G01S 5/00

(52) U.S. Cl. CPC G01S 5/0072
USPC 342/385

(57) ABSTRACT

The invention relates to a system (20) for locating a missing aircraft based on the monitoring and storage of successive positions of aircraft in a group of aircraft flying near one another, including:

an ADS-B-out transmitter (22) installed on each aircraft and capable of transmitting information relative to the identifier and position of that aircraft,

an ADS-B-in receiver (28) installed on each aircraft and capable of receiving information transmitted by the ADS-B-out transmitters (22) of other aircraft located near it;

characterized in that the ADS-B-in receiver (28) of each aircraft includes a memory (30) capable of saving information (29) received from other aircraft, and in that it includes means for recovering the information for a posteriori reconstruction of at least part of the successive positions of at least one missing aircraft from the group in order to facilitate the location of that aircraft.

This claims the benefit of French Patent Application FR1301439, filed Jun. 20, 2013 and hereby incorporated by reference herein.

The present invention relates to a system for locating a missing aircraft.

More particularly, the invention relates to such a system for locating a missing aircraft based on the monitoring and storage of successive positions of aircraft in a group of aircraft flying near one another, of the type including:

an ADS-B-out transmitter installed on each aircraft and capable of transmitting information relative to the identifier and position of that aircraft,

an ADS-B-in receiver installed on each aircraft and capable of receiving information transmitted by the ADS-B-out transmitters of other aircraft located near it.

### BACKGROUND

Different aircraft location systems exist in the state of the art.

Thus, for example, for aircraft in nominal flight, i.e., capable of communicating with their surroundings, in particular to send data, the ADS-B (Automatic Dependent Surveillance-Broadcast)-type location system allows an aircraft to transmit position information in its surroundings.

The position of that aircraft is defined by a satellite positioning system and is transmitted at a given frequency through a corresponding onboard ADS-B-out transmitter.

This position information is thus transmitted to be subsequently accessible, for example, to all systems surrounding the transmitting aircraft, and equipped with a corresponding ADS-B-in receiver.

These systems are for example other aircrafts or ground stations.

Thus, for example, such an ADS-B-in receiver can be onboard another aircraft and for example makes it possible to complete the traditional traffic alert and collision avoidance (TCAS) system.

Some ground stations are also equipped with an ADS-B-in receiver, which makes it possible to facilitate management of the traffic in zones covered little or not at all by air control radars.

Furthermore, the information on the position of the aircraft provided by the ADS-B-out system is generally more precise than that delivered by radars or TCAS systems.

Furthermore, other types of location systems exist making it possible to identify a “missing” aircraft. A missing aircraft is an aircraft that is no longer emitting a signal that would make it possible to find it. This is particularly crucial in uncontrolled airspace, inhospitable zones or large maritime expanses.

An aircraft can also be considered as missing or been lost for example following accidental landing or in the case of an accident leading to total or partial destruction of the aircraft.

In the latter case, a rescue operation must be organized quickly. This operation will be more effective if the position information of the aircraft is precise.

In particular, following an accident, the distress beacons of a missing aircraft are provided to transmit a signal allowing their positioning during a length of time that may nominally reach one month, even if the aircraft disappeared in the ocean. However, after some accidents, these beacons stop transmitting prematurely, which becomes an obstacle in finding an aircraft that suffered an accident.

The problem of locating an aircraft just after its accident is well known and has been the subject of research within various competent entities, such as the Bureau Enquête Accident [Accident Investigation Bureau] in France or the International Civil Aviation Organization, for example.

One of the solutions currently proposed to resolve these problems of position determination consists of having the aircraft send a distress signal in an accident situation, that signal containing its position just before the accident.

However, this solution has a certain number of drawbacks.

For example, many difficulties appear in establishing a criterion that is acceptable to everyone and defining this accident situation anticipating the imminent consequences for the flight of the aircraft realistically enough.

In fact, it is difficult to strike a balance between late transmission of the signal, at the risk that the equipment capable of transmitting it may have already been lost, and premature transmission, at the risk of triggering a false alarm or transmitting imprecise location information.

A premature transmission is in fact no more desirable, since it is subsequently difficult to predict the trajectory of the aircraft and the precise location of its accident.

Additionally, because such a system does not exist onboard aircraft, another difficulty would be to add that system in each aircraft that may one day disappear. The present invention aims to propose a system for locating a missing aircraft making it possible to resolve these problems and reconstitute the trajectory of a missing aircraft in the safest way possible, using systems already existing onboard airplanes and making the least expensive possible changes thereto.

### SUMMARY OF THE INVENTION

The present invention provides a system for locating a missing aircraft, of the aforementioned type, characterized in that the ADS-B-in receiver of each aircraft includes a memory capable of saving information received from other aircraft, and in that it includes means for recovering the information for a posteriori reconstruction of at least part of the successive positions of at least one missing aircraft from the group in order to facilitate the location of that aircraft.

According to other features of the system according to the invention, considered alone or in combination:

the memory dedicated to the ADS-B-in receiver is associated with the traffic alert and collision avoidance system (TCAS);

each new piece of information received by the ADS-B-in receiver can be saved in the memory by overwriting the oldest information already present therein from among the information already stored;

the location system includes means for optimizing the memory of the ADS-B-in receiver in order to keep only significant information on the positions of the concerned aircraft;

the period of time during which the memory dedicated to the ADS-B-in receiver is capable of saving the received information is several hours;

the location system includes means for activating freezing of the saved information;

the freezing means are made up of an actuator activated on the orders of an air control authority;

the freezing means are made up of an actuator activated under the orders of the crew of the aircraft; and

the freezing means are applied exclusively for a given aircraft.

### BRIEF DESCRIPTION OF THE DRAWINGS

The invention will be better understood upon reading the following description, provided solely as an example and done in reference to the appended drawings, in which:

FIG. 1 is a diagrammatic view illustrating a group of aircraft flying near one another and implementing a location system according to the invention; and

FIG. 2 is a diagrammatic view illustrating the operation of such a system for locating a missing aircraft.

### DETAILED DESCRIPTION

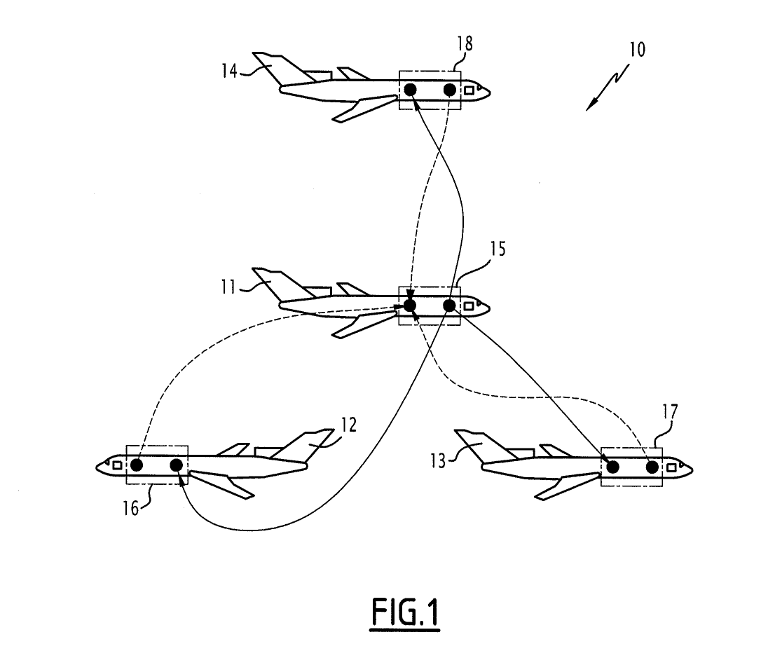

FIG. 1 in fact illustrates a group 10 of aircraft flying near one another.

This group 10 of aircraft is for example shown by airplanes, of which there are for example four, designated by references 11, 12, 13 and 14, respectively, performing commercial flights and flying near one another for a variable length of time.

Of course, other types of aircraft may be considered.

It should be noted that two aircraft are considered to fly in the immediate vicinity of one another if they are located within detection range by the specific equipment onboard them.

This specific onboard equipment is designated using general references 15, 16, 17 and 18, respectively, and for example consists of a traffic alert and collision avoidance system (TCAS) and/or an ADS-B-in (Automatic Dependent Surveillance-Broadcast) receiver.

These systems are well known in the state of the art and will therefore not be described in more detail below.

Thus, the airplanes of the group 10 are capable of communicating with each other by exchanging information as illustrated in FIG. 1.

Each piece of equipment includes a location system 20 according to the invention and is thus installed on each airplane in the group 10.

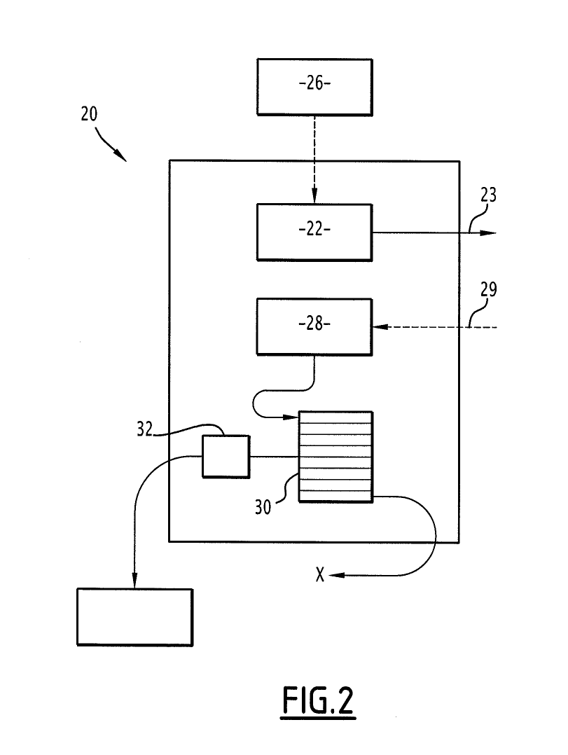

One example embodiment of such a system 20 is diagrammatically illustrated in FIG. 2.

This system 20 then includes an ADS-B-out transmitter 22 capable of transmitting information in the form of messages 23 into the environment of the aircraft with a determined transmission frequency.

In general, these messages 23 include an aircraft identifier and its current position.

For airplanes, the aircraft identifier is for example its flight number.

The current position of the aircraft is determined by a satellite positioning system 26.

According to one example embodiment, this information is transmitted every 1 or 2 seconds, for example.

The system 20 also comprises an ADS-B-in receiver 28 capable of receiving messages 29 coming from one or more other aircraft in the group 10 and which are then transmitted by the ADS-B-out transmitter 22 of the corresponding aircraft.

The system 20 further includes a memory 30 capable of saving at least part of the messages 29 received during a particular period of time.

This period of time is generally equal to the duration of an average flight and for example corresponds to several hours.

According to one example embodiment, the memory 30 is associated with the traffic alert and collision avoidance system (TCAS).

This for example makes it possible to reuse equipment already onboard and avoid having to provide for new installations on the aircraft.

When each new message 29 reaches the ADS-B-in receiver 28, it can be written in the memory 30, for example by overwriting the oldest message already present therein.

The messages are therefore written in a loop.

Thus, for example, if the quantity of incoming messages exceeds the maximum capacity of the memory 30, only the most recent messages can be saved to the memory 30.

In one example embodiment, the system also includes means for optimizing the memory 30.

In that case, the optimization means make it possible to filter the incoming messages 29, keeping only messages containing significant information.

Thus, the optimizing means for example make it possible to erase information relating to the same aircraft and containing the intermediate positions of a rectilinear travel trajectory thereof.

Of course, other embodiments of the optimizing means can be considered.

The system 20 also includes means 32 making it possible to activate freezing of the information saved in the memory 30.

These means 32 for example include a manual or automatic actuator that can be operated under the orders of an air control authority or the crew.

The operation of the system 20 for locating a missing aircraft according to the invention will now be described.

Each aircraft therefore transmits, via its ADS-B-out transmitter, messages containing its identifier and its current position with a given transmission frequency.

These messages are received by all of the aircraft in the group through their corresponding ADS-B-in receivers.

These messages are next saved in the memory of each of the aircraft.

The optimizing means can be used in order to keep only significant information in the memory of each aircraft, as previously explained.

These messages will subsequently make it possible, in case of problem, to specify the position of a missing aircraft.

Indeed, in the event an aircraft is considered as missing, an air control authority may for example activate or order freezing of the information saved in the memory of each aircraft that was part of a group of aircraft including the aircraft that vanished during at least part of its flight.

Such a freezing command may also be given exclusively for a given aircraft. That aircraft is for example determined from its stored identifier.

This information may then for example be used by the air control authority or the entities responsible for investigating aircraft accidents to reconstitute, a posteriori, all or at least part of the trajectory of the missing aircraft in order to determine the accident location as precisely as possible.

One can then see that this makes it possible to simplify and accelerate the location of a missing aircraft in order to begin rescue operations as quickly as possible.

This is obtained by using equipment already onboard, by simply adding memory thereto.

Of course, other embodiments may be considered.

What is claimed is:

1-9. (canceled)

10. A system for locating a missing aircraft based on the monitoring and storage of successive positions of aircraft in a group of aircraft flying near one another, the system comprising:
an ADS-B-out transmitter installed on each aircraft and capable of transmitting information relative to the identifier and position of the respective aircraft,
an ADS-B-in receiver installed on each aircraft and capable of receiving information transmitted by the ADS-B-out transmitters of other aircraft located nearby;
the ADS-B-in receiver of each aircraft including a memory capable of saving information received from other aircraft, and a recoverer for recovering the information for a posteriori reconstruction of at least part of the successive positions of at least one missing aircraft from the group in order to facilitate the location of the missing aircraft.

11. The location system as recited in claim 10 wherein the memory dedicated to the ADS-B-in receiver is associated with a traffic alert and collision avoidance system.

12. The location system as recited in claim 10 wherein each new piece of information received by the ADS-B-in receiver is savable in the memory by overwriting oldest information already present therein from among the information already stored.

13. The location system as recited in claim 10 further comprising an optimizer for optimizing the memory of the ADS-B-in receiver in order to keep only significant information on the positions of the concerned aircraft.

14. The location system as recited in claim 10 wherein a period of time during which the memory dedicated to the ADS-B-in receiver is capable of saving the received information is several hours.

15. The location system as recited in claim 10 further comprising a freezer for activating freezing of the saved information.

16. The location system as recited in claim 15 wherein the freezer includes an actuator activated on the orders of an air control authority.

17. The location system as recited in claim 16 wherein the freezer includes an actuator activated under orders of a crew of the aircraft.

18. The location system as recited in claim 17 wherein the freezer is applied exclusively for a given aircraft.
